(19) United States
(12) Patent Application Publication
(10) Pub. No.: US 2002/0093716 A1
(43) Pub. Date: Jul. 18, 2002

(54) Optical heterodyne frequency modulator

(76) Inventor: Maki Hiraizumi, Kawasaki-shi (JP)

Correspondence Address: STAAS & HALSEY LLP, 700 11TH STREET, NW, SUITE 500, WASHINGTON, DC, 20001, US

(21) Appl. No.: 10/028,266

(22) Filed: Dec. 28, 2001

Related U.S. Application Data
(62) Division of application No. 09/210,907, filed on Dec. 16, 1998, now abandoned.

(30) Foreign Application Priority Data
Mar. 9, 1998 (JP) 10-056559

(51) Int. Cl. G02F 1/00; G02B 26/00

(52) U.S. Cl. 359/237

(57) ABSTRACT

Disclosed is an optical heterodyne frequency modulator for outputting an FM signal by driving a frequency modulating laser diode with an input signal to generate an FM optical signal, combining waves of a local optical signal with waves of the FM optical signal, and subjecting the combined signal to optical heterodyne detection to output the FM signal which is frequency-modulated by the input signal. A signal having a phase opposite that of a signal input to a frequency modulating laser diode is generated, the amplitude of the FM optical signal, which is output by the frequency modulating laser diode, is controlled in such a manner that the optical power is rendered constant, the amplitude-modulated FM optical signal and the local optical signal are combined, and the combined signal is then subjected to optical heterodyne detection, whereby an FM signal is produced as an output.

### CROSS-REFERENCE TO RELATED APPLICATIONS

This application is a divisional application of Parent Application Ser. No. 09/210,907 filed Dec. 16, 1998 and incorporated herein by reference.

### BACKGROUND OF THE INVENTION

### FIELD OF THE INVENTION

This invention relates to an optical heterodyne frequency modulator and, more particularly, to an optical heterodyne frequency modulator for removing residual AM components contained in an FM signal.

A frequency modulator using optical heterodyne technology generates a frequency-modulated (FM) optical signal by driving a frequency modulating laser diode using a predetermined input signal, combines the waves of a local optical signal output by a local laser diode with the waves of the FM optical signal, subjects the combined signal to optical heterodyne detection to generate the FM signal which is frequency-modulated by the input signal and outputs the resultant FM signal.

FIG. 9 is a diagram illustrating the construction of an optical heterodyne frequency modulator according to the prior art, as well as the spectra of the associated signals. Numeral 1 denotes a frequency modulating laser diode (FM-LD) driven by an input signal I(t) for generating an FM optical signal of frequency f₁, numeral 2 a local laser diode (LO-LD) for outputting a local optical signal of frequency f₂, 3 an optical multiplexer (polarization-preserving coupler) for combining the FM optical signal and the local optical signal in such a manner that the states of polarization are made the same, 4 an optical heterodyne detector comprising a photodiode (PD), and 5 a high-pass filter.

The oscillation wavelength of a laser diode varies in proportion to a diode current I in the manner shown by an I-f characteristic (a) in FIG. 10. If the signal I(t) is input to the FM laser diode 1, the latter outputs an FM optical signal S1. A local optical signal S2 having an optical wavelength approximately the same as that of the FM optical signal S1 is generated by the local laser diode 2. The FM optical signal S1 and the local optical signal S2 are combined by the polarization-preserving coupler 3 to produce a combined signal S3. If the combined signal S3 undergoes square-law detection in the photodiode PD, the FM optical signal S1 can be converted to an FM signal S-4 of a frequency band in which the signal can be treated as an electric signal.

The characteristic of a laser diode is such that optical power P also varies in proportion to the current I, as shown by the I-P characteristic (b) of FIG. 10. If the signal I(t) is input to the FM laser diode 1 to perform frequency modulation, therefore, amplitude modulation is applied at the same time and AM components (residual AM signals) are superposed upon the output FM optical signal S1 as unnecessary signals. As a result, with the conventional optical heterodyne frequency modulator, the FM optical signal S1 is converted to the FM signal S4, which has the frequency band in which the signal can be treated as an electric signal, in a state in which the residual AM signals are superposed thereon. Thus, the FM signal S4 contains residual AM signals. This has a deleterious effect upon the noise characteristic and waveform of the demodulated signal.

In view of these circumstances, use is made of the method in which the residual AM signals are eliminated by using the high-pass filter 5 shown in FIG. 9. However, since this causes degradation of the passed FM signal, it is required that the high-pass filter 5 have a flat group delay characteristic in the pass band as well as a sharp cut-off characteristic in order to remove the residual AM signals. It is difficult to design a high-pass filter that has both of these characteristics and, in reality, only filters that sacrifice one or both of the characteristics are currently available. As a consequence, a satisfactory AM-signal eliminating characteristic and a flat group delay characteristic cannot be obtained. This leads to noise and distortion.

The foregoing can be described using equations to express the signals associated with the various circuit components. Specifically, the FM laser diode 1 has such a characteristic that optical power and oscillation wavelength vary in proportion to the amount of infected current. If the input signal is I(t), therefore, the FM optical signal S1 can be expressed as follows:

S1=2·[A2+αI(t)]^{½}·cos[ω₁+2πγ∫I(t)dt]

where α and γ represent the modulation index and the FM index, respectively, and ω₁=2πf₁ holds. If the local optical signal S2 output by the local laser diode 2 is expressed by

S2=2·B·cos(ω₂t)

(where ω₂=2πf₂ holds), then the combined signal S3 from the coupler 3 obtained by combining the signals S1 and S2 will be represented by the following equation:

$$\begin{matrix}S3 = ( S1 + S2 ) / 2 \\ = {[ {A}^{2} + α I ( t ) ]}^{1 / 2} \cdot cos [ {ω}_{1} t + 2 πγ \int I ( t ) ⅆ t ] + B \cdot cos ( {ω }_{2} )\end{matrix}$$

The combined signal S3 undergoes optical heterodyne detection (square-law detection) to obtain the FM signal S4 indicated by the following equation:

$$\begin{matrix}S4 = [ {A}^{2} + {B}^{2} + α I ( t ) ] + 2 B \cdot {[ {A}^{2} + α I ( t ) ]}^{1 / 2} \cdot \\ cos [ \vert {ω}_{1} - {ω}_{2} \vert t + 2 πγ \int I ( t ) ⅆ t ]\end{matrix} \qquad ( 1 )$$

Thus, optical heterodyne detection furnishes the FM signal S4 having the DC component and low-frequency component (the ω₁−ω₂ component) indicated by the above equation from which high-frequency components (2ω₁, 2ω₂, ω₁+ω₂ components) have been removed. In the FM signal S4, αI(t) contained in the first term and αI(t) contained in the amplitude of cos in the second term are residual AM components and 2πγ∫I(t)dt is an FM component. Thus, the output of the frequency modulator contains residual AM components. This has an adverse effect upon transmission quality. Accordingly, the optical heterodyne frequency modulator of FIG. 9 is provided with the high-pass filter 5 to remove αI(t) contained in the first term. However, this leads to the problem set forth above.

FIG. 11 is a diagram showing another configuration of an optical heterodyne frequency modulator according to the prior art. There is no high-pass filter used in this example. Components in FIG. 11 identical with those shown in FIG. 8 are designated by like reference characters. Shown in FIG. 11 are the FM laser diode 1, the local laser diode 2, the polarization-preserving coupler 3 and the optical heterodyne detector 4. Numeral 6 denotes a 180° coupler which rotates the phase of the input signal I(t) by 180°, i.e., which reverses the sign of the signal, 7 a signal combiner, 8 a delay controller for delaying the inverted input signal −I(t) until the FM signal S4 output by the detector 4 enters the signal combiner 7, and an amplitude controller 9 for multiplying the inverted input signal −I(t) by α.

Since the signal combiner 7 combines −αI(t) with S4 of Equation (1), which is the output of the optical heterodyne detector 4, the signal combiner 7 outputs a signal S5′ given by the following equation:

S5′=(A²+B²)+2B·[A²+αI(t)]^{½}·cos[|ω₁−ω₂|t+2πγ∫I(t)dt]

As a result, residual AM components contained in the first term of the FM signal S4 output by the optical heterodyne detector 4 can be eliminated without using a high-pass filter.

However, in order to eliminate the residual AM signals by the scheme of FIG. 11, a problem which arises is the need for phase adjustment by a delay line. Moreover, with the scheme of FIG. 11, it is necessary to adjust phase with respect to a signal that has passed through a large number of components, namely the FM diode, optical fiber, the polarization-preserving coupler and the photodiode. This makes a long delay line necessary, resulting in an apparatus of large size.

In addition, with the schemes of FIGS. 9 and 11, another problem is that it is not possible to eliminate the residual AM components superposed upon the FM signal, namely the residual AM components ascribable to αI(t) contained in the amplitude of cos of the second term in Equation (1).

### SUMMARY OF THE INVENTION

Accordingly, an object of the present invention is to dispense with the high-pass filter and delay line required in the prior art and eliminate residual AM signal components by an apparatus of small size and through simple control.

Another object of the present invention is to eliminate residual AM signal components correctly even if the components constructing an optical heterodyne frequency modulator having fluctuating characteristics.

A further object of the present invention is to eliminate residual AM signal components in first and second terms from the output (FM signal S4) of a optical heterodyne detector.

In accordance with the present invention, the foregoing objects are attained by provided first through fifth optical heterodyne frequency modulators described below.

In a first optical heterodyne frequency modulator according to the present invention, a signal having a phase opposite that of an input signal is input to a canceling laser diode provided separately of a frequency modulating laser diode and local laser diode, the optical outputs of these laser diodes are combined and subsequently subjected to optical heterodyne detection to thereby output an FM signal. If this arrangement is adopted, the residual AM signal components in the first term of Equation (1) can be eliminated by an apparatus of small size and through simple control without using a high-pass filter or delay line.

In a second optical heterodyne frequency modulator according to the present invention, a signal having a phase opposite that of an input signal is input to a local laser diode, and the optical output of a frequency modulating laser diode and the optical output of the local laser diode are combined and subsequently subjected to optical heterodyne detection to thereby output an FM signal. If this arrangement is adopted, the residual AM signal components in the first term of Equation (1) can be eliminated by an apparatus of small size and small number of parts and through simple control without using a high-pass filter or delay line. Further, since FM signals of apposite phase are combined, it is possible to obtain an FM signal having twice the frequency deviation. As a result, the amount of frequency deviation of each laser diode can be halved. This makes it possible to reduce the size of the apparatus and to reduce power consumption.

Further, in the second optical heterodyne frequency modulator according to the present invention, the FM optical signal output by the frequency modulating laser diode is received by a photodiode to extract residual AM signal components contained in the FM optical signal, the residual AM signal components are inverted by an inverting amplifier and the inverted signals are input to the local laser diode as signals having a phase opposite that of the input signal. If this arrangement is adopted, residual AM signal components can be eliminated stably even if the frequency modulating laser diode has a fluctuating characteristic.

In a third optical heterodyne frequency modulator according to the present invention, a signal having a phase opposite that of an input signal is generated, an FM optical signal output by a frequency modulating laser diode is subjected to amplitude control by the signal of opposite phase in such a manner that the amplitude of the signal is rendered constant, and the FM optical signal whose amplitude has been controlled and a local optical signal are combined and subsequently subjected to optical heterodyne detection to thereby output an FM signal. If this arrangement is adopted, the amplitude of the FM optical signal can be rendered constant. As a result, residual AM signal components can be eliminated completely and both the apparatus and control can be simplified.

Further, in the third optical heterodyne frequency modulator according to the present invention, the amplitude control is performed using an external modulator (LN modulator) having a variable refractive index. More specifically, the FM optical signal output by the frequency modulating laser diode is received by a photodiode to extract residual AM signal components contained in the FM optical signal, the residual AM signal components are inverted by an inverting amplifier and the inverted signals are input to the LN modulator as signals having a phase opposite that of the input signal, and the LN modulator performs amplitude control in such a manner that the amplitude of the FM optical signal is rendered constant. If this arrangement is adopted, residual AM signal components can be eliminated stably even if the frequency modulating laser diode has a fluctuating characteristic.

In a fourth optical heterodyne frequency modulator according to the present invention, an FM optical signal output by a frequency modulating laser diode is subjected to amplitude control in such a manner that the amplitude thereof is rendered constant, the FM optical signal Whose amplitude has been controlled and a local optical signal are combined and subsequently subjected to optical heterodyne detection, an output obtained by such optical heterodyne detection is caused to branch and residual AM signal components are extracted, and the aforesaid amplitude control is performed based upon level of the extracted residual AM signal components. If this arrangement is adopted, residual AM signal components can be eliminated completely and, moreover, the residual AM signal components can be eliminated correctly even if the structural components of the optical heterodyne frequency modulator have fluctuating characteristics.

In a fifth optical heterodyne frequency modulator according to the present invention, a signal having a phase opposite that of an input signal is generated, the amplitude of a local optical signal from a local laser diode is controlled using the signal of opposite phase, and an FM optical signal output by a frequency modulating laser diode and the local optical signal whose amplitude has been controlled are combined and subsequently subjected to optical heterodyne detection to thereby output an FM signal. If this arrangement is adopted, the residual AM signal components in the first term of Equation (1) can be eliminated by an apparatus of small size and a small number of parts and through simple control without using a high-pass filter or delay line.

Other features and advantages of the present invention will be apparent from the following description taken in conjunction with the accompanying drawings.

### BRIEF DESCRIPTION OF THE DRAWINGS

FIG. 1 is a diagram showing the construction of an optical heterodyne frequency modulator according to a first embodiment of the present invention;

FIG. 2 is a diagram showing the construction of an optical heterodyne frequency modulator according to a first embodiment of the present invention;

FIG. 3 is a block diagram showing a modification of the second embodiment;

FIG. 4 is a diagram showing the construction of an optical heterodyne frequency modulator according to a third embodiment of the present invention;

FIG. 5 is a block diagram showing a first modification of the third embodiment;

FIG. 6 is a block diagram showing a second modification of the third embodiment;

FIG. 7 is a diagram showing the construction of an optical heterodyne frequency modulator according to a fourth embodiment of the present invention;

FIG. 8 is a block diagram illustrating an example of application of an optical heterodyne frequency modulator according to the present invention;

FIG. 9 is a diagram showing the construction of an optical heterodyne frequency modulator according to the prior art;

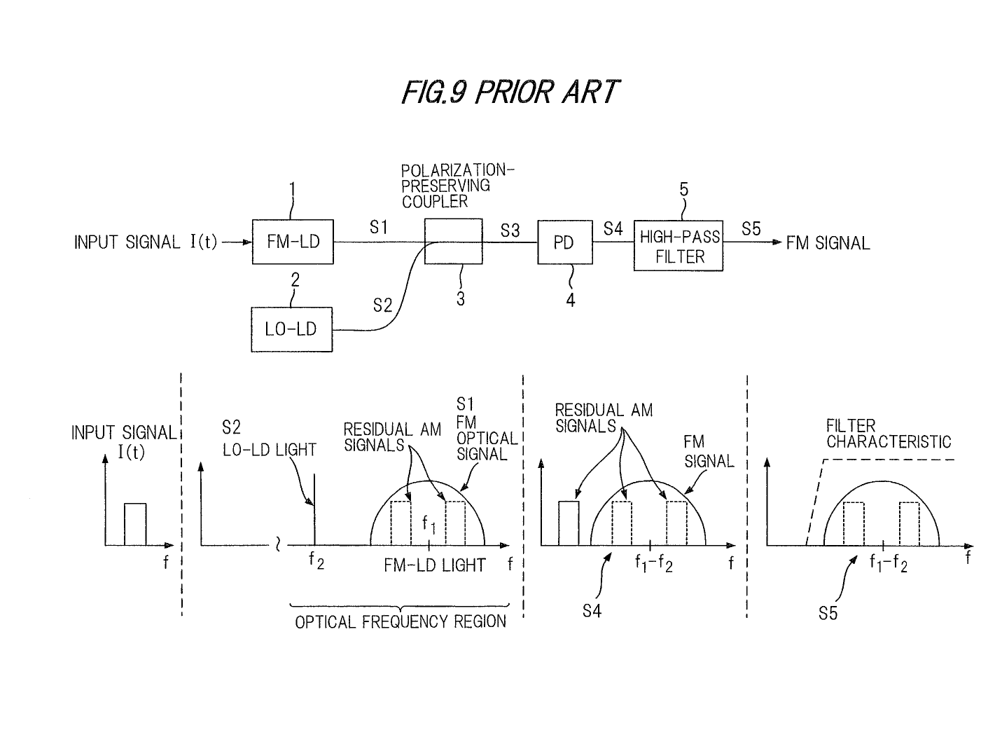

FIG. 10 is a diagram useful in describing the characteristics of a laser diode; and

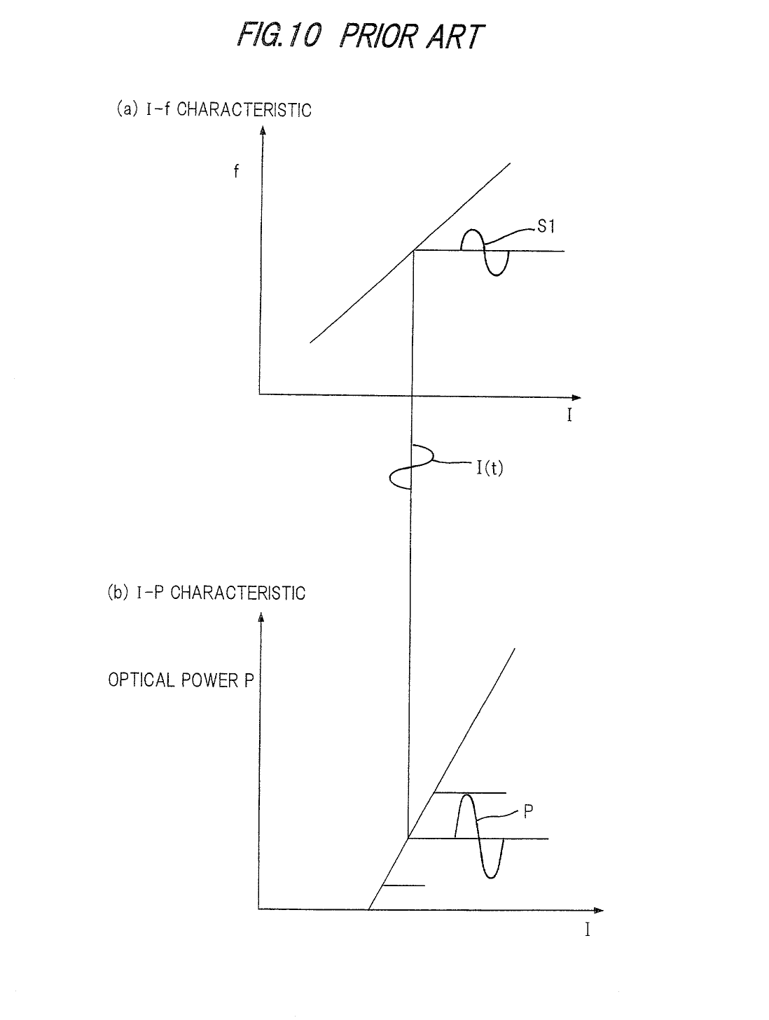

FIG. 11 is a diagram showing the construction of an another optical heterodyne frequency modulator according to the prior art.

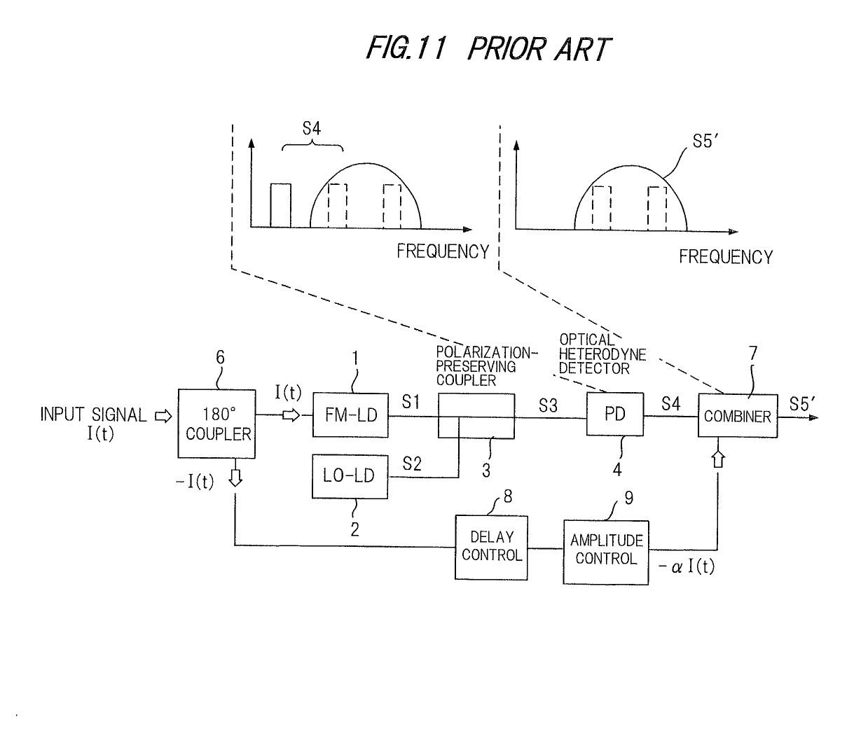

### DETAILED DESCRIPTION OF THE PREFERRED EMBODIMENTS

(A) First embodiment

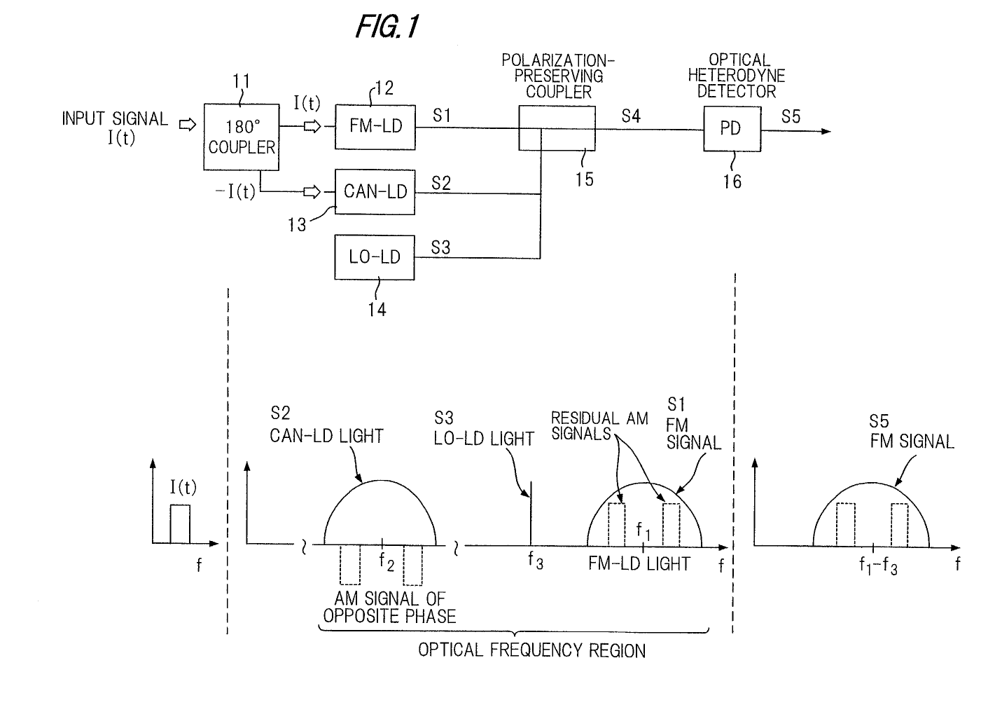

FIG. 1 is a diagram showing the construction of an optical heterodyne frequency modulator according to a first embodiment of the present invention, as well as the spectra of the associated signals.

As shown in FIG. 1, the frequency modulator includes a 180° coupler 11 which outputs an input signal I(t) as is and a signal −I(t) obtained by rotating the phase of the input signal by 180°, an FM laser diode 12 driven by the input signal I(t) for generating an FM optical signal S1 of frequency f₁, a canceling laser diode 13 driven by the inverted input signal −I(t) for generating a canceling FM optical signal S2 of frequency f₂, a local laser diode 14 for outputting a local optical signal of frequency f₃, an optical multiplexer (polarization-preserving coupler) 15 for combining the optical output signals of the laser diodes 12-14 in such a manner that the states of polarization are made the same, and an optical heterodyne detector 16 comprising a photodiode (PD). The optical heterodyne detector 16 subjects the combined signal S4 output by the coupler 15 to square-law detection to convert the FM optical signal S1 to an FM signal S5 of a frequency band in which the signal can be treated as an electric signal.

If the input signal is I(t), therefore, the FM optical signal S1 output by the FM laser diode 12 can be expressed as follows:

S1=4·(A²+αI(t))^{½}·cos[ω₁t+2πγ∫I(t)dt]

where α and γ represent the modulation index and the FM index, respectively, and ω₁=2ρf₁ holds. The canceling FM optical signal S2 output by the canceling laser diode 13 can be expressed as follows:

S2=4·[B²−βI(t)]^{½}·cos[ω₂t−2πγδ∫I(t)dt]

where β represents the modulation index and δ the frequency modulation index and ω₂=2πf₂ holds.

If a local optical signal S3 output by the local laser diode 14 is expressed by

S3=4·C·cos(ω₃t)

(where ω₃=2πf₃ holds), then the combined signal S4 output by the polarization-preserving coupler 15 will be represented by the following equation:

$$\begin{matrix}S4 = ( S1 + S2 + S3 ) / 4 \\ = {[ {A}^{2} + α I ( t ) ]}^{1 / 2} \cdot cos [ {ω}_{1} t + 2 πγ \int I ( t ) ⅆ t ] + \\ {[ {B}^{2} - β I ( t ) ]}^{1 / 2} \cdot cos [ {ω}_{2} t - 2 π δ \int I ( t ) ⅆ t ] + \\ C \cdot cos ( {ω}_{3} t )\end{matrix}$$

The optical heterodyne detector 16 subjects the combined signal S4 to square-law detection and outputs an FM signal S5. If α=β holds under the following conditions: ω₁=ω₃, ω₁>>ω₂, the, the FM signal S5 will be written as follows:

S5=(A²+B²+C²)+2C[A²+αI(t)]^{½}·cos[|ω₁−ω₃|t+2πγ∫I(t)dt]

More specifically, by virtue of optical heterodyne detection, the DC component and low-frequency component (the ω₁−ω₃ component) indicated by the above equation from which high-frequency components have been eliminated are output as the FM signal S5. As a result, in accordance with the first embodiment, the residual AM component αI(t) contained in the first term of Equation (1) can be eliminated from the FM signal by an apparatus of small size and through simple control without using a high-pass filter or delay line, which are necessary in the prior art.

(B) Second Embodiment

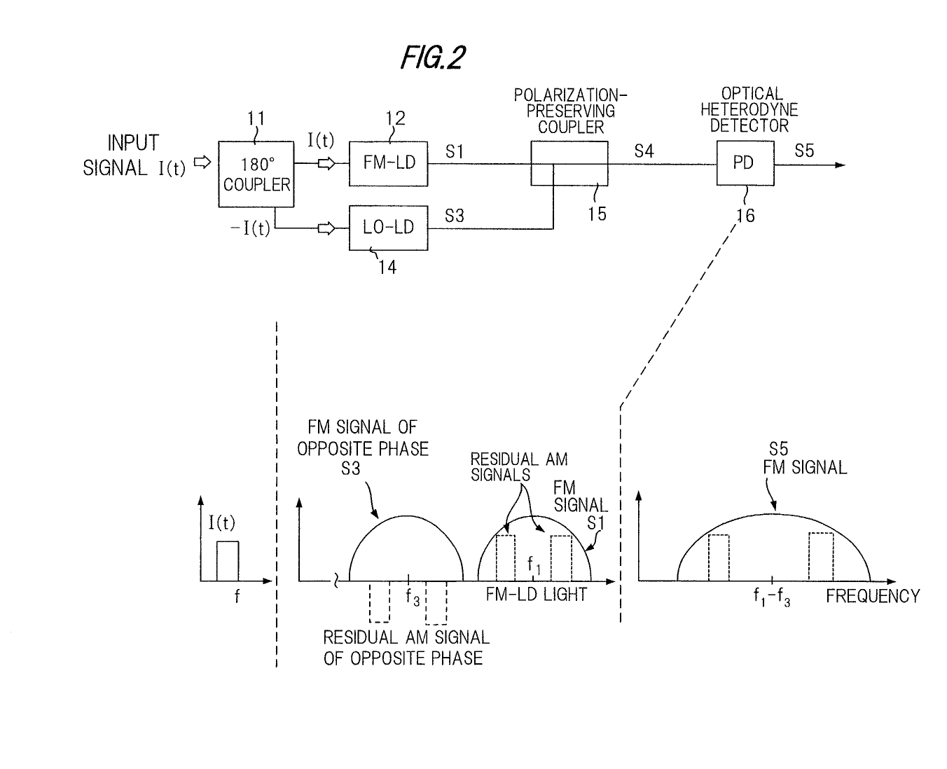

FIG. 2 is a diagram showing the construction of an optical heterodyne frequency modulator according to a second embodiment of the present invention.

As shown in FIG. 2, the frequency modulator includes the 180° coupler 11 which outputs the input signal I(t) as is and the signal −I(t) obtained by rotating the phase of the input signal by 180°, the FM laser diode 12 driven by the input signal I(t) for generating the FM optical signal S1 of frequency f₁, the local laser diode 14, to which the inverted input signal −I(t) is applied, for outputting a local optical signal S3 of frequency f₃, the polarization-preserving coupler 15 for combining the optical output signals of the laser diodes 12 and 14 in such a manner that the states of polarization are made the same, and the optical heterodyne detector 16 comprising the photodiode (PD). The optical heterodyne detector 16 subjects the combined signal S4 output by the coupler 15 to square-law detection to convert the FM optical signal S1 to the FM signal S5 of a frequency band in which the signal can be treated as an electric signal.

If the input signal is I(t), the FM optical signal S1 output by the FM laser diode 12 can be expressed as follows:

S1=2·[A²+αI(t)]^{½}·cos[ω₁t+2πγ∫I(t)dt]

where α and γ represent the modulation index and the FM index, respectively, and ω₁=2πf₁ holds. The local optical signal S3 output by the local laser diode 24 can be expressed as follows:

S3=2·[B²−βI(t)^{½}·cos[ω₃t−2πδ∫I(t)dt]

where β represents the modulation index and δ the FM index and ω₃=2πf₃ holds.

Accordingly, the polarization-preserving coupler 15 outputs the combined signal S4 indicated by the following equation:

$$\begin{matrix}S4 = ( S1 + S ) / 2 \\ = {[ {A}^{2} + α I ( t ) ]}^{1 / 2} \cdot cos [ {ω}_{1} t + 2 πγ \int I ( t ) ⅆ t ] + \\ {[ {B}^{2} - β I ( t ) ]}^{1 / 2} \cdot cos [ {ω}_{3} t - 2 π δ \int I ( t ) ⅆ t ]\end{matrix}$$

The optical heterodyne detector 16 subjects the combined signal S4 to square-law detection and outputs an FM signal S5 indicated by the following equation:

S5=(A²+B²)+2[A²+αI(t)]^{½}·[B²βI(t)]^{½}·cos[|ω₁−ω₃|t+2π(γ+δ)∫I(t)dt]

More specifically, by virtue of optical heterodyne detection, the DC component and low-frequency component (the ω₁−ω₃ component) indicated by the above equation from which high-frequency components have been eliminated are output as the FM signal S5. As a result, in accordance with the second embodiment, the residual AM component αI(t) contained in the first term of Equation (1) can be eliminated from the FM signal by an apparatus of small size and through simple control without using a high-pass filter or delay line, which are necessary in the prior art.

Further, in accordance with the second embodiment, FM optical signals which are opposite in phase (the output of the frequency modulating laser diode 12 and the output of the local laser diode 14) are combined. As a result, an FM signal having a frequency deviation 2π(γ+δ)∫I(t) dt that is twice the usual frequency deviation can be obtained. This means that the amounts of frequency deviation of the two laser diodes 12 and 14 can be halved and makes it possible to reduce the size of the apparatus and to reduce power consumption.

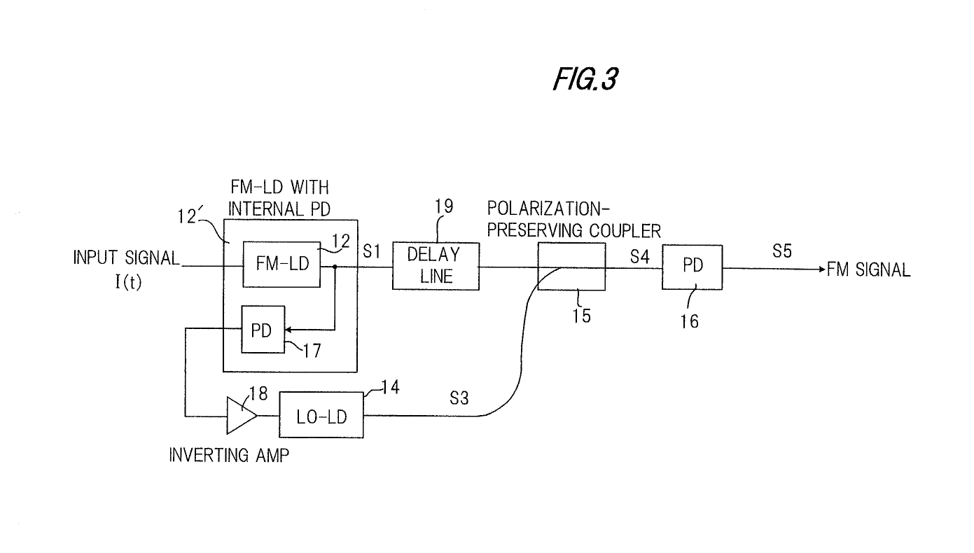

FIG. 3 illustrates a modification of the second embodiment. In FIG. 2, the signal −I(t), which is the inverse of the input signal I(t), is generated using the 180° coupler 11. In this modification, however, a frequency modulating laser diode 12′ having an internal photodiode 17 is provided. The FM optical signal S1 output by the frequency modulating laser diode 12 is received by the photodiode 17 to extract residual AM signal components contained in the FM optical signal, the polarity of these residual AM signals is reversed by an inverting amplifier 18, and the inverted signals are input to the local laser diode 14 as signals having a phase opposite that of the input signal I(t). A delay line 19 for phase matching is provided between the frequency modulating laser diode 12 and the polarization-preserving coupler 15 to perform phase matching.

The FM optical signal S1 can be expressed as follows:

S1=[A²+αI(t)]^{½}·cos[ω₁t+2πγ∫I(t)dt]

Since the photodiode 17 subjects the FM optical signal S1 to square-law detection, the output of the photodiode 17 is as follows:

A²+αI(t)

Inverting this signal by the inverting amplifier 18 causes −αI(t) to be input to the local laser diode 14. As a result, the residual AM signal component αI(t) contained in the first term of Equation (1) can subsequently be eliminated from the FM signal through a procedure similar to that of the second embodiment. According to this modification, stable AM suppression can be realized even if the FM laser diode 12 has a fluctuating characteristic.

(C) Third Embodiment

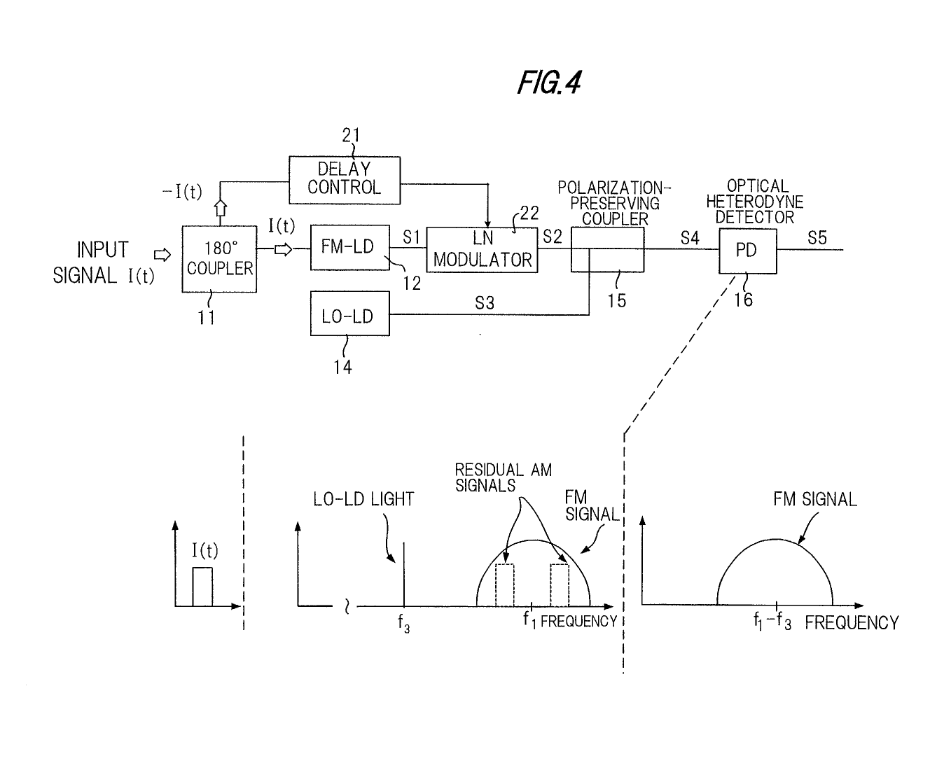

FIG. 4 is a diagram shaving the construction of an optical heterodyne frequency modulator according to a third embodiment of the present invention.

As shown in FIG. 4, the frequency modulator includes the 180° coupler 11 which outputs the input signal I(t) as is and the signal −I(t) obtained by rotating the phase of the input signal by 180°, the FM laser diode 12 driven by the input signal I(t) for generating the FM optical signal S1 of frequency f₁, the local laser diode 14 for outputting the local optical signal S3 of frequency f₃, a delay controller (delay line) 21 which performs control for phase matching, and a modulator (LN modulator) 22 referred to as an LiNb0₃ external modulator or variable refractive-index external modulator. The LN modulator 22 controls the power (amplitude) of the optical input signal by an external signal. More specifically, the LN modulator 22 amplitude-modulates the power (amplitude) of the FM optical signal (optical input signal) S1 by the inverted input signal −I(t) and outputs an optical signal S2 of constant power. The frequency modulator further includes the polarization-preserving coupler 15 for combining the output signal S2 of the LN modulator 22 and the optical output signal of the local laser diode 14 in such a manner that the states of polarization are made the same, and the optical heterodyne detector 16 comprising the photodiode (PD). The optical heterodyne detector 16 subjects the combined signal S4 output by the coupler 15 to square-law detection to convert the FM optical signal S1 to the FM signal S5 of a frequency band in which the signal can be treated as an electric signal.

If the input signal is I(t), the FM optical signal S1 output by the FM laser diode 12 can be expressed as follows:

S1=2·[A²+αI(t)]^{½}·cos[ω₁t+2πγ∫I(t)dt]

where α and γ represent the modulation index and the FM index, respectively, and ω₁=2πf₁ holds. Further, the optical output signal S2 of the LN modulator 22 has its amplitude held constant and can be expressed as follows:

S2=2A·cos[ω₁t+2πγ∫I(t)dt]

Accordingly, if the local optical signal output by the local laser diode 14 is represented by

S3=2·B·cos(ω₃t),

where ω₃=2πf₃ holds, then the combined signal S4 output by the polarization-preserving coupler 15 will be as follows:

S4=(S2+S3)/2=A·cos[ω₁t+2πγ∫I(t)dt]+B·cos(ω₃t)

The optical heterodyne detector 16 subjects the combined signal S4 to square-law detection and outputs an FM signal S5 indicated by the following equation:

S2=(A²+B²)+2A·B·cos[|ω₁−ω₃|t+2πγ∫I(t)dt]

More specifically, by virtue of optical heterodyne detection, the DC component and low-frequency component (the ω₁−ω₃ component) indicated by the above equation from which high-frequency components have been eliminated are output as the FM signal S5, thereby it is possible to completely eliminate residual AM signal components. Though the delay line 21 is required in the third embodiment, just as in the prior art, the amount of delay provided is small. As a result, the apparatus is comparatively small and control can be performed in simple fashion.

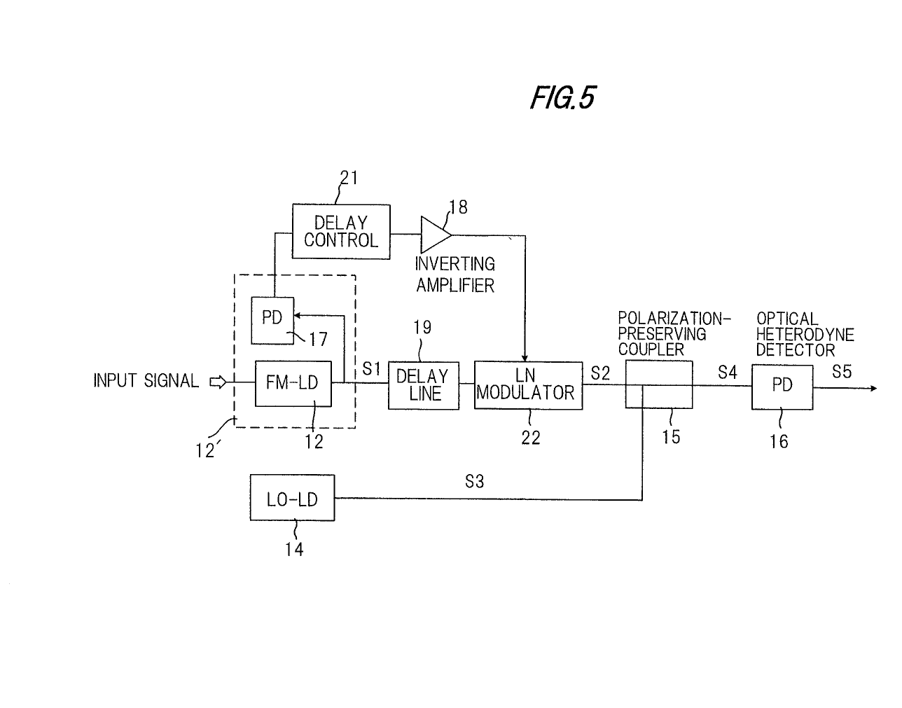

FIG. 5 illustrates a first modification of the third embodiment. In FIG. 4, the signal −I(t), which is the inverse of the input signal I(t), is generated using the 180° coupler 11. In this modification, however, the frequency modulating laser diode 12′ having the internal photodiode 17 is provided. The FM optical signal S1 output by the frequency modulating laser diode 12 is received by the photodiode 17 to extract residual AM signal components contained in the FM optical signal, a delay for phase matching is applied, the polarity of these residual AM signals is reversed by the inverting amplifier 18, and the inverted signals are input to the LN modulator 22. The latter controls the amplitude (power) of the FM optical signal S1 by the inverted residual AM signals and outputs the optical signal S2 of constant amplitude. The delay line 19 for phase matching is provided.

The FM optical signal S1 is as follows:

S1=(A²+αI(t)]^{½}·cos[ω₁t+2πγ∫I(t)dt]

Since the photodiode 17 subjects the FM optical signal S1 to square-law detection, the output of the photodiode 17 is as follows:

A²+αI(t)

Inverting this signal by the inverting amplifier 18 causes −αI(t) to be input to the LN modulator 22. As a result, the residual AM component αI(t) can be completely eliminated from the FM signal through a procedure similar to that of the third embodiment. According to this modification, stable AM suppression can be realized even if the FM laser diode 12 has a fluctuating characteristic.

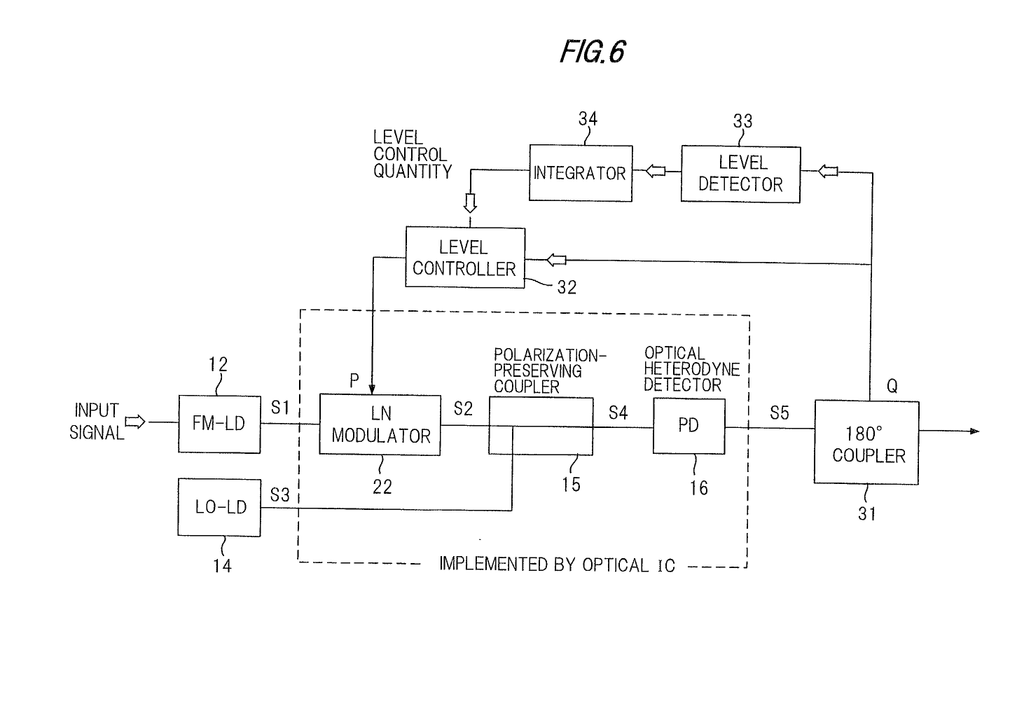

FIG. 6 illustrates a second modification of the third embodiment. In FIG. 4, amplitude control (amplitude modulation) is performed in the LN modulator 22 in feed-forward fashion. In this modification, however, residual AM signal components contained in the FM signal S5 are detected and amplitude control is performed by feedback in such a manner that the residual AM signal components become zero.

A 180° coupler 31 rotates the phase of the FM signal S5, which is output by the optical heterodyne detector 16, by 180°, and inputs the resulting signal to a level controller 32 and, via a level detector 33, to an integrator 34. The integrator 34 detects the residual AM components contained in the FM signal S5 and outputs a level control quantity in dependence upon the residual AM components. The level controller 32 controls the level of the inverted FM signal by the level control quantity and inputs the controlled signal to the LN modulator 22. The latter performs amplitude control (amplitude modulation) based upon the signal that enters from the level controller 32 and carries out feedback control so as to eliminate the residual AM components contained in the FM signal S5.

In accordance with this modification, residual AM signal components can be eliminated completely and, moreover, the residual AM signal components can be eliminated correctly even if the structural components (the FM laser diode, the polarization-preserving coupler and the photodiode, etc.) of the optical heterodyne frequency modulator have fluctuating characteristics. In this modification, the band over which feedback suppression can be performed is limiting owing to the delay time from a control point P to a detection point Q. However, the band can be broadened by using an optical integrated circuit for the portion enclosed by the dashed line in FIG. 6.

(D) Fourth Embodiment

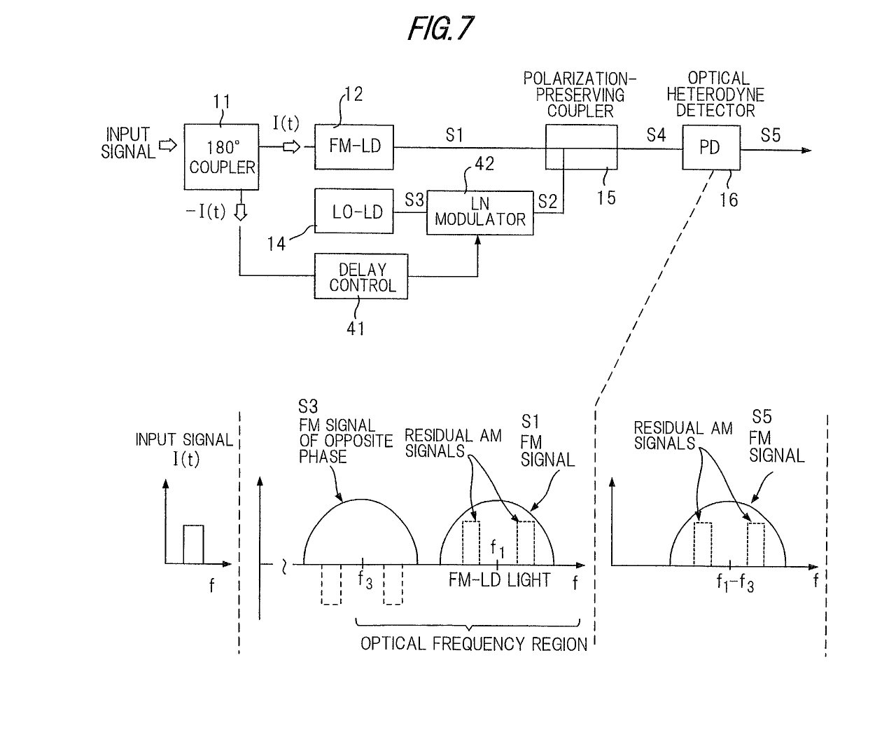

FIG. 7 is a diagram showing the construction of an optical heterodyne frequency modulator according to a fourth embodiment of the present invention.

As shown in FIG. 4, the frequency modulator includes the 180° coupler 11 which outputs the input signal I(t) as is and the signal −I(t) obtained by rotating the phase of the input signal by 180°, the FM laser diode 12 driven by the input signal I(t) for generating the FM optical signal S1 of frequency f₁, the local laser diode 14 for outputting the local optical signal S3 of frequency f₃, a delay controller (delay line) 21 which performs control for phase matching, and an LN modulator 42 for controlling the amplitude (power) of the optical input signal by an external signal. More specifically, the LN modulator 42 controls the amplitude (power) of the local optical signal S3, which is the output of the local laser diode 14, by the inverted input signal and outputs an optical signal S2. The frequency modulator further includes the polarization-preserving coupler 15 for combining the output signal S2 of the LN modulator 42 and the optical output signal of the FM laser diode 12 in such a manner that the states of polarization are made the same, and the optical heterodyne detector 16 comprising the photodiode (PD). The optical heterodyne detector 16 subjects the combined signal S4 output by the coupler 15 to square-law detection to convert the FM optical signal S1 to the FM signal S5 of a frequency band in which the signal can be treated as an electric signal.

If the input signal is I(t), the FM optical signal S1 output by the FM laser diode 12 can be expressed as follows:

S1=2·(A²+αI(t)]^{½}·cos[ω₁t+2πγ∫I(t)dt]

where α and γ represent the modulation index and the FM index, respectively, and ω₁=2πf₁ holds. Further, if the local optical signal S3 output by the local laser dude 14 is represented by

S3=2·B·cos(ω₃t)

where ω₃=2πf₃ holds, then the optical signal S2 output by the LN modulator 42 will be as indicated by the following equation owing to amplitude control by the inverted input signal −I(t):

S2=2·[B²−βI(t)]^{½}·cos(ω₃t)]

Accordingly, the combined signal S4 output by the polarization-preserving coupler 15 is as indicated by the following equation:

$$\begin{matrix}S4 = ( S1 + S ) / 2 \\ = {[ {A}^{2} + α I ( t ) ]}^{1 / 2} \cdot cos [ {ω}_{1} t + 2 πγ \int I ( t ) ⅆ t ] + \\ {[ {B}^{2} - β I ( t ) ]}^{1 / 2} \cdot cos ( {ω}_{3} t )\end{matrix}$$

The optical heterodyne detector 16 subjects the combined signal S4 to square-law detection and outputs an FM signal S5 indicated by the following equation:

S5=(A²+B²)+2[A²+αI(t)]^{½}·[B²−βI(t)]^{½}·cos[|ω₁−ω₃|t+2πγ∫I(t)dt]

More specifically, by virtue of optical heterodyne detection, the DC component and low-frequency component (the ω₁−ω₃ component) indicated by the above equation from which high-frequency components have been eliminated are output as the FM signal S5. As a result, in accordance with the fourth embodiment, the residual AM signal component αI(t) contained in the first term of Equation (1) can be eliminated from the FM signal. Though a delay line is required in the fourth embodiment, just as in the prior art, the amount of delay provided is small. As a result, the apparatus is comparatively small and control can be performed in simple fashion.

(E) Application of the Invention

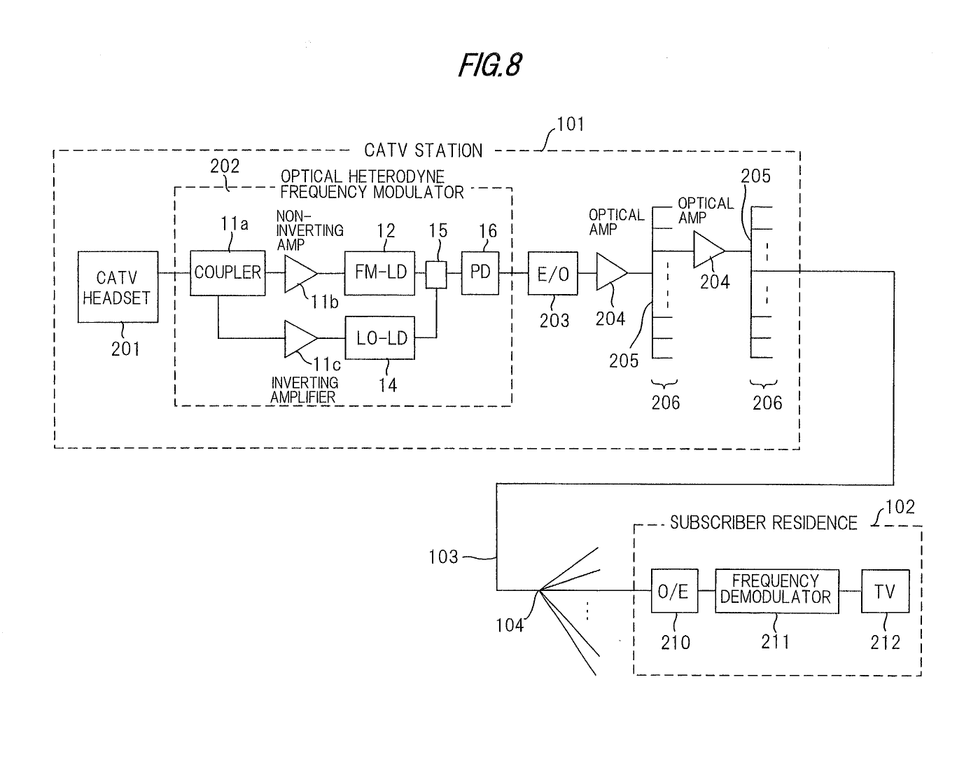

FIG. 8 is a diagram showing the construction of a CATV network serving as an example of application of an optical heterodyne frequency modulator according to the present invention. This example of application uses the arrangement of the second embodiment (FIG. 2) as the optical heterodyne frequency modulator. The network shown in FIG. 8 includes a CATV station 101, a subscriber residence 102, an optical cable 103 for transmitting a video signal, and a branch point 104.

The CATV station 101 includes a CATV headset 201 for sending a video signal, an optical heterodyne frequency modulator 202, an electro-optic (E/O) transducer 203 for changing an electric signal to an optical signal, an optical amplifier 204, a branch point 205 and an optical cable 206. The construction of the optical heterodyne frequency modulator 202 is somewhat different from that of the second embodiment. Specifically, instead of the 180° coupler, a branching coupler 11a, non-inverting amplifier 11b and inverting amplifier 11c are used to generate a signal whose phase is opposite that of the input signal.

The subscriber residence 102 includes an electro-optic (E/O) transducer 210 for changing an electric signal, which enters via an optical cable, to an optical signal, a frequency demodulator 211 for demodulating the frequency-modulated video signal, and a TV receiver 212 for outputting video and audio.

The video signal output by the CATV headset 201 is frequency modulated by the optical heterodyne frequency modulator 202, the FM signal is converted to an optical signal by the electro-optic transducer 203, the optical signal is allotted to the subscriber residence 102 via the optical cable, and the desired video signal is demodulated at the subscriber residence 102 and output to the TV receiver 212.

Thus, in accordance with the present invention, a signal having a phase opposite that of an input signal is input to a canceling laser diode provided separately of a frequency modulating laser diode and local laser diode, the optical outputs of these laser diodes are combined and subsequently subjected to optical heterodyne detection to thereby output an FM signal. As a result, residual AM signal components can be eliminated by an apparatus of small size and through simple control without using a high-pass filter or delay line.

In accordance with the present invention, a signal having a phase opposite that of an input signal is input to a local laser diode, and the optical output of a frequency modulating laser diode and the optical output of the local laser diode are combined and subsequently subjected to optical heterodyne detection to thereby output an FM signal. As a result, residual AM signal components can be eliminated by an apparatus of small size and small number of parts and through simple control without using a high-pass filter or delay line. Further, since FM signals of opposite phase are combined, it is possible to obtain an FM signal having twice the frequency deviation. As a result, the amount of frequency deviation of each laser diode can be halved. This makes it possible to reduce the size of the apparatus and to reduce power consumption. If it is so arranged that a signal of opposite phase is generated using an FM optical signal output by the frequency modulating laser diode, residual AM signal components can be eliminated stably even if the frequency modulating laser diode has a fluctuating characteristic.

In accordance with the present invention, a signal having a phase opposite that of an input signal is generated, an FM optical signal output by a frequency modulating laser diode is subjected to amplitude control by a signal of opposite phase in such a manner that the amplitude of the signal is rendered constant, and the FM optical signal whose amplitude has been controlled and a local optical signal are combined and subsequently subjected to optical heterodyne detection to thereby output an FM signal. As a result, the amplitude of the FM optical signal can be rendered constant. This makes it possible to completely eliminate residual AM signal components and to simplify both the apparatus and control.

In accordance with the present invention, an FM optical signal output by a frequency modulating laser diode is subjected to amplitude control in such a manner that the amplitude thereof is rendered constant, the FM optical signal whose amplitude has been controlled and a local optical signal are combined and subsequently subjected to optical heterodyne detection, an output obtained by such optical heterodyne detection is caused to branch and residual AM signal components are extracted, and the aforesaid amplitude control is performed in such a manner that the level of the extracted residual AM signal components is made zero. As a result, residual AM signal components can be eliminated completely and, moreover, the residual AM signal components can be eliminated correctly even if the structural components of the optical heterodyne frequency modulator have fluctuating characteristics.

In accordance with the present invention, a signal having a phase opposite that of an input signal is generated, the amplitude of a local optical signal output by a local laser diode is controlled using the signal of opposite phase, and an FM optical signal output by a frequency modulating laser diode and the local optical signal whose amplitude has been controlled are combined and subsequently subjected to optical heterodyne detection to thereby output an FM signal. As a result, residual AM signal components can be eliminated by an apparatus of small size and a small number of parts and through simple control without using a high-pass filter or delay line.

As many apparently widely different embodiments of the present invention can be made without departing from the spirit and scope thereof, it is to be understood that the invention is not limited to the specific embodiments thereof except as defined in the appended claims.

What is claimed is:

1. An optical heterodyne frequency modulator for outputting an FM signal by driving a frequency modulating laser diode with an input signal to generate an FM optical signal, combining waves of a local optical signal with waves of the FM optical signal, and subjecting the combined signal to optical heterodyne detection to output the FM signal which is frequency-modulated by the input signal, comprising:
means for generating a signal having a phase opposite that of a signal input to the frequency modulating laser diode;
amplitude control means for performing amplitude control using the signal having the opposite phase in such a manner that the amplitude of the FM optical signal output by said frequency modulating laser diode is rendered constant;
a local laser diode for generating the local optical signal;
means for combining the FM optical signal whose amplitude has been controlled and the local optical signal and outputting the combined signal; and
an optical heterodyne detector for subjecting the combined signal to optical heterodyne detection and outputting an FM signal which is frequency-modulated by the input signal.

2. The frequency modulator according to claim 4, wherein said amplitude control means performs amplitude control using an external modulator having a variable refractive index.

3. The frequency modulator according to claim 5, wherein said means for generating the signal having opposite phase includes:
a photodiode for extracting a residual AM signal component contained in the FM optical signal output by said frequency modulating laser diode; and
an inverting amplifier for reversing polarity of the residual AM signal component and outputting an inverted signal obtained by the polarity reversal;
the inverted signal being input to said external modulator having the variable refractive index.

4. An optical heterodyne frequency modulator for outputting an FM signal by driving a frequency modulating laser diode with an input signal to generate an FM optical signal, combining waves of a local optical signal with waves of the FM optical signal, and subjecting the combined signal to optical heterodyne detection to output the FM signal which is frequency-modulated by the input signal, comprising:
amplitude control means for performing amplitude control in such a manner that the amplitude of the FM optical signal output by said frequency modulating laser diode is rendered constant;
a local laser diode for generating the local optical signal;
means for combining the FM optical signal whose amplitude has been controlled and the local optical signal and outputting the combined signal;
an optical heterodyne detector for subjecting the combined signal to optical heterodyne detection and outputting an FM signal which is frequency-modulated by the input signal; and
means for branching an output from said optical heterodyne detector and extracting a residual AM signal component;
said amplitude control means performing amplitude control based upon level of the residual AM signal component.
